(19) United States
(12) Patent Application Publication
(10) Pub. No.: US 2020/0236773 A1
(43) Pub. Date: Jul. 23, 2020

(54) PLASMA GENERATING APPARATUS

(71) Applicant: THE BOARD OF REGENTS FOR THE OKLAHOMA AGRICULTURAL AND MECHANICAL COLLEGES, STILLWATER, OK (US)

(72) Inventors: KEDAR K. PAI, STILLWATER, OK (US); CHRIS TIMMONS, STILLWATER, OK (US)

(21) Appl. No.: 16/746,514

(22) Filed: Jan. 17, 2020

Related U.S. Application Data
(60) Provisional application No. 62/794,372, filed on Jan. 18, 2019.

(51) Int. Cl. H05H 1/24; H05H 1/46

(52) U.S. Cl. CPC H05H 1/2406; H05H 2001/2443; H05H 2001/2412; H05H 1/46

(57) ABSTRACT

A plasma generating apparatus includes a dielectric medium with electrodes on first and second sides of the dielectric medium. A power source creates a voltage differential between the electrodes on the first side and the electrodes on the second side of the dielectric medium. Plasma is generated on both of the first and second sides of the dielectric medium as a result of the voltage differential.

### CROSS REFERENCE TO RELATED APPLICATION

This application claims the benefit of U.S. Provisional Application 62/794,372 filed on Jan. 18, 2019, which is incorporated by reference.

### BACKGROUND

This disclosure relates generally to a plasma generating device and to systems and methods of using the device to decontaminate objects. Plasma is known to be decontamination medium for a number of biological agents. Plasma is generated, at least in one instance, by applying a differential voltage to electrodes on opposite sides of a dielectric medium. Known devices cover the electrodes on one side of the dielectric medium with a substrate that prevents the generation of plasma and plasma-generated reactive species. As a result, plasma is generated only on one side of the dielectric medium. Before proceeding to a description of the present invention it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

The current disclosure is directed to a plasma generating apparatus. The plasma-generating apparatus may include a plasma generating sheet. The plasma generating sheet may include a dielectric medium, which may be referred to as a dielectric barrier and a plurality of first electrodes positioned on a first side of the dielectric medium. A plurality of second electrodes is positioned on a second side of the dielectric medium. A power supply connected to the electrodes on one of the first or second sides is configured to create a voltage differential between the first electrodes and the second electrodes. Plasma is generated on both of the first and second sides of the dielectric medium in response to the applied voltage difference. The first and second electrodes are configured such that both will generate plasma upon the application of the voltage differential. Neither of the first or second electrodes is covered with a substrate that will prevent or inhibit the generation of plasma and plasma-generated reactive species.

In some embodiments at least a portion of the plurality of the first and second electrodes is covered by a non-plasma-inhibiting corrosion-resistant material. In addition, in some embodiments the dielectric medium will be covered with the non-plasma-inhibiting corrosion-resistant material. The non-plasma-inhibiting corrosion-resistant material will not prevent or inhibit plasma generation, but may extend the life of the plasma generating sheet by protecting the dielectric barrier and the electrodes from etching and corrosion.

In additional embodiments side edges of the plurality of first electrodes are spaced apart from side edges of adjacent second electrodes to define a lateral gap therebetween. In other embodiments there is an overlap between the side edges of the plurality of the first and the side edges of adjacent second electrodes. In both embodiments, the first electrodes are offset from adjacent second electrodes. A power supply may be used to create the voltage differential.

A decontamination chamber disclosed herein may comprise a sealed enclosure, with the dielectric medium and first and second electrodes positioned in an interior of the sealed enclosure. The power supply is configured to be connected to the electrodes on one of the first or second sides of the dielectric barrier to create the voltage differential between first electrodes and second electrodes. The power supply may provide power pulses of a designated length of time, with lapses where no power is supplied and as a result no additional plasma is generated in the lapse period. A pump may be included and used to pump, or withdraw plasma-generated reactive species from the sealed enclosure. The pump may pass the reactive species through a filter to convert to oxygen and nitrogen which can be pumped back into the sealed enclosure. The pump may be configured to pulse between on and off positions, wherein in the on position the pump removes reactive species from the enclosure and pumps air into the enclosure.

The current disclosure is also directed to a method of forming plasma. The method may comprise positioning electrodes on both of first and second sides of a dielectric medium and simultaneously creating plasma on both of the first and second sides of the dielectric medium. The simultaneously creating step may comprise applying a voltage to electrodes on one of the first and second sides of the dielectric medium to create a differential voltage. Power may be pulsed at designated lengths of time and at designated duty cycles to prevent excessive heat production. The method may comprise coating at least a portion of the electrodes with a non-plasma-inhibiting corrosion-resistant material, and coating all or a portion of the dielectric medium.

An additional method may comprise enclosing the dielectric medium in an enclosure and generating plasma and plasma-generated reactive species in the enclosure. The method can comprise pumping the reactive species from the enclosure and pumping air into the enclosure. Pumping may occur continuously, or a pulse rate in which the pump is on for a predetermined period of time and off for a predetermined amount of time.

A method of decontaminating an object according to the current disclosure comprises exposing the object to plasma-generated reactive species in the enclosure for a predetermined length of time. The method includes exposing the object until such time as the object is decontaminated, or if desired until sterilization occurs. Although described embodiments disclose application of voltage to electrodes on one side of the dielectric medium, it is understood that the voltage differential may be created by applying voltage to the electrodes on both sides of the dielectric medium.

### BRIEF DESCRIPTION OF THE DRAWINGS

These and further aspects of the invention are described in detail in the following examples and accompanying drawings.

FIG. 1 is a schematic diagram of one embodiment of a plasma generating device according to the present disclosure.

FIG. 2 is a schematic diagram of another plasma generating device according to the present disclosure.

FIG. 3 is a schematic diagram of a plasma decontamination system according to the present disclosure.

FIG. 4 is a side profile view of some example relative positions of upper and lower conductors that are suitable for use with various embodiments of the present disclosure.

FIG. 5 provides schematic illustrations of linear and annular example electrode configurations of the present disclosure.

FIG. 6 is a plan view of an annular embodiment of an electrode configuration.

FIG. 7 is a side profile view of a progression of relative motive force for some configurations of the embodiment of FIG. 6.

FIG. 8 is a side profile view of a progression of asymmetrical motive force that may be produced by the embodiment of FIG. 6.

FIG. 9 is a plan view of another embodiment of the present disclosure employing multiple annular electrodes.

FIG. 10 is a cross-sectional view of another annular embodiment of the present disclosure.

FIG. 11 contains schematic illustrations of additional electrode configurations of the present disclosure.

FIG. 12 is a perspective view of a plasma pouch decontamination device according to the present disclosure.

FIG. 13 is an end cutaway view of the plasma pouch of FIG. 12.

FIG. 14 is a perspective view of a system employing the plasma pouch of FIG. 12 for decontamination purposes.

FIG. 15 is a perspective view of an additional embodiment of a plasma generating apparatus.

FIG. 16 schematically shows an embodiment of a plasma generating sheet for use with the plasma generating apparatus.

FIG. 17 schematically shows an additional embodiment of a plasma generating sheet for use with the plasma generating apparatus.

FIG. 18 schematically shows a decontamination chamber of the current disclosure.

FIG. 19 is a table reflecting the results of a test that shows the plasma volume increase resulting from a power increase.

FIG. 20 is a table showing the effect of an enclosure volume on decontamination/sterilization efficiency.

FIG. 21 is a graph showing enclosure temperature at different power pulse rates.

FIG. 22 is a graph showing temperature at different power pulse and pump pulse rates.

### DETAILED DESCRIPTION

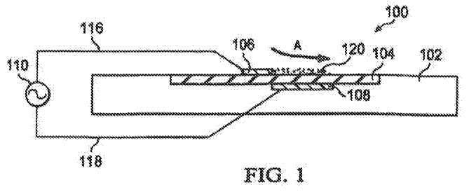

Referring now to FIG. 1, a schematic diagram of one embodiment of a plasma-generating device according to the present disclosure is shown. In the embodiment of FIG. 1, the device 100 includes a substrate 102 onto which the various other components described herein may be attached. As will be explained in greater detail below, the substrate 102 could be a portion of a chamber or enclosure. A suitable substrate 102 would be a non-conductive, impermeable material that is resistant to high temperatures or gas species. Glass, acrylic or phenolic materials are examples of acceptable materials.

Integrated with the substrate 102, or forming a part of the substrate 102, is a dielectric layer 104. The dielectric layer 104 could be formed, by way of example only, from any material with a low dielectric constant such as PTFE or kapton.

An electrode 106 is situated along a top surface of the dielectric layer 104. A second electrode 108 is situated along a lower surface of the dielectric layer 104. It can be seen that the electrodes 106, 108, are at least somewhat offset from one another along a length of the dielectric layer 104. The electrodes 106 and 108 might be made of copper or any other material with suitable conductivity.

The electrode 106 attaches to a voltage source 110 by an electrical lead 116. The electrode 108 attaches to the voltage source 110 by an electrical lead 118. In the present embodiment, the voltage source 110 may include a power supply as well as any necessary transformers or circuit conditioning components to enable generation of plasma by application of sufficient voltage between the electrodes 106, 108 on the surface of the dielectric layer 104. In the present embodiment, a plasma region 120 develops between the first electrode 106 and the second electrode 108. The plasma region 120 also provides a motive force for any adjacent gases in the direction of the arrow “A.”

Various duty cycles and voltages may be utilized to generate plasma. In the present embodiment, various voltages, frequencies and duty cycles have been tested and found to be operational. By way of example only, these include voltages in the range of 5 to 50 kV at frequencies of 1,000 to 10,000 Hz at a 10% to 100% duty cycle at modulated frequencies of 1, 2, 5, 10, 100, 500 and 5000 Hz. It will be appreciated that various flow rates and associated decontamination characteristics can be generated by adjusting the duty cycle voltage and frequency of the applied voltage. In application, the limit is most likely to be the durability of the materials used to construct the device 100 and the available power supply. For example, if operating from commercial power, higher voltages may be available than if operating from battery power.

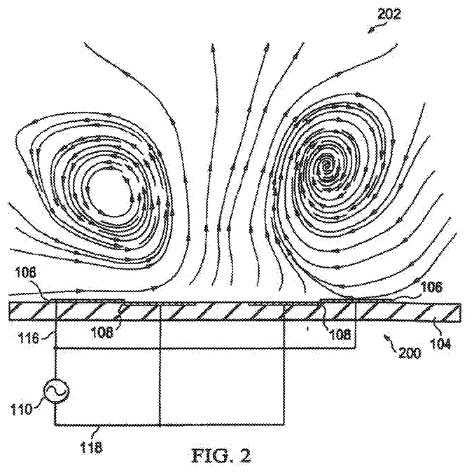

Referring now to FIG. 2, a schematic diagram of another plasma generating device according to the present disclosure is shown. The device 200 is similar in construction and operation to the device 100 of FIG. 1. In the present device, two upper electrodes 106 are attached opposite a dielectric layer 104, and are offset from a pair of lower electrodes 108. Electrical lead 116 attaches the upper electrodes 106 to the voltage source 110 and a lower electrical lead 118 attaches the lower electrodes 108 to the voltage source 110.

In the present embodiment, it will be appreciated that, due to the configuration of the electrodes 106 relative to the electrodes 108, flow regions that are pointed in substantially opposite directions will be achieved. Thus, each electrode pair 106, 108, will generate plasma as well as a motive force pointed inward according to FIG. 2. This will cause a swirling effect of any adjacent gases as illustrated by the exemplary flow lines 202.

In FIG. 2, both of the upper electrodes 106 are shown attached to a common voltage line 116. Similarly, the lower electrodes 108 are shown attached to a common voltage line 118. Thus, in operation, in this embodiment the upper electrodes 106 will always be at the same voltage potential while the lower electrodes 108 will likewise share a voltage potential. However, it is understood that other configurations are possible. For example, both of the upper electrodes 106 need not necessarily be operated at the same voltage level. Similarly, the lower electrodes 108 could be attached to different voltage levels. In this manner the device 200 may be operated in a pulsing fashion where the gas flow is first in one direction, and then in another. It will be appreciated that both of the aforedescribed exemplary operating methods will result in a thorough mixing of gases next to and around the device 200. Thus, over time the adjacent gases will be exposed to the plasma generated by the device and the air thereby decontaminated from biological agents.

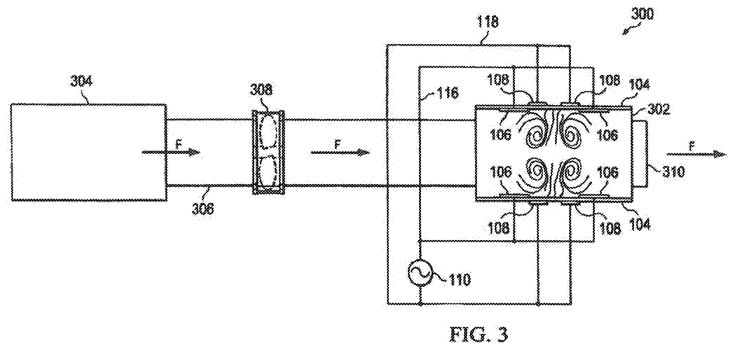

Referring now to FIG. 3, a schematic diagram of a plasma decontamination system according to the present disclosure is shown. The plasma decontamination system 300 comprises a plasma decontamination chamber 302. This chamber 302 may have a plurality of inner electrodes 106 separated from a plurality of outer electrodes 108 by a dielectric layer 104. The dielectric layer 104 may be enclosed by a substrate (not shown).

The inner electrodes 106 may attach to a voltage source 110 by a lead 116. The outer electrodes 108 may attach to the voltage source 110 by a lead 118. The plasma decontamination system 300 operates in a manner similar to those previously described in that voltages will be applied to the plurality of inner electrodes 106 and outer electrodes 108 generating plasma inside the plasma decontamination chamber 302. The motive forces provided by the plasma generation will serve to mix and swirl gas within the plasma decontamination chamber 302 such that the gases inside of the chamber 302 may be substantially completely decontaminated from biological agents.

In some embodiments, the motive force for drawing contaminated air into the plasma decontamination chamber 302, and expelling decontaminated air, will be entirely due to the location and configuration of the plasma generating electrodes 106, 108 in and on the plasma decontamination chamber 302. However, in other embodiments, a separate flow control system may be utilized that provides for selective introduction of contaminated gases into the decontamination chamber 302 from a contamination source 304. The contamination source 304 could be naturally or otherwise occurring bacteria or viruses, medical waste, sewage or any number of sources which generate air containing bio-contaminants. In the present embodiment, the gases flow generally from the contamination source 304 in the direction of the arrows “F.”

A conduit 306 is provided between the plasma decontamination chamber 302 and the contamination source 304. A fan 308 may be provided that produces vacuum toward the contamination source 304, and positive pressure toward the plasma decontamination chamber 302. The fan 308 or other flow driving device may operate in an open-loop configuration or may be selectively activated such that air within the decontamination chamber 302 has sufficient time for exposure to plasma to achieve a satisfactory level of decontamination. An exit conduit 310 may be provided for moving the decontaminated gas away from the decontamination chamber 302. In some embodiments, the exit conduit 310 will merely function as a selectively closeable valve to prevent air from escaping the decontamination chamber 302 until sufficiently and effectively decontaminated.

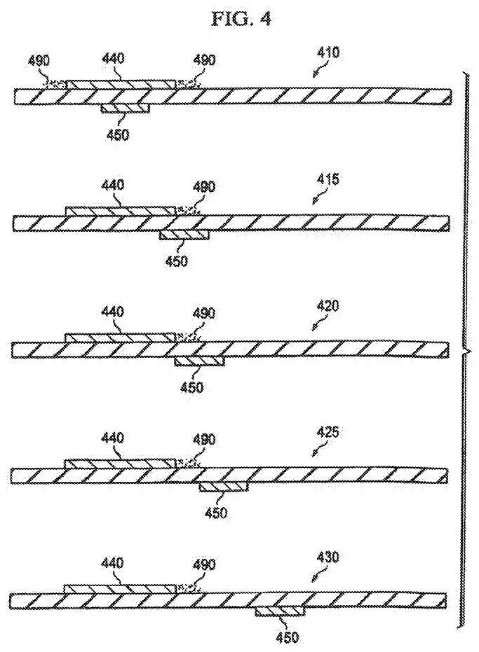

FIGS. 4-11 illustrate additional embodiments of the present disclosure. In FIG. 4, configuration 410 is an embodiment that operates to generate a plasma stream 490 on both sides of the upper conductor 440 at its periphery. However, some embodiments tend to produce better results when the upper 440 and lower 450 conductors at least partially overlap, tends to produce better results (e.g., 410 and 415). Further, and continuing with the examples of FIG. 4, configurations such as 420 to 430 tend to show generally decreasing performance as compared with configuration 415. Obviously, if the conductors are spaced sufficiently far apart the plasma generated will be negligible or zero.

FIG. 5 contains a schematic illustration of linear 520 and annular 510 embodiments. As can be seen, in the embodiments of this figure the motive force associated with the plasma stream is in an outward (upward by reference to this figure) direction, i.e., a “blow” embodiment. That being said, if the electrical leads are reversed, a downward/inward (i.e., a “suck”) embodiment can be created.

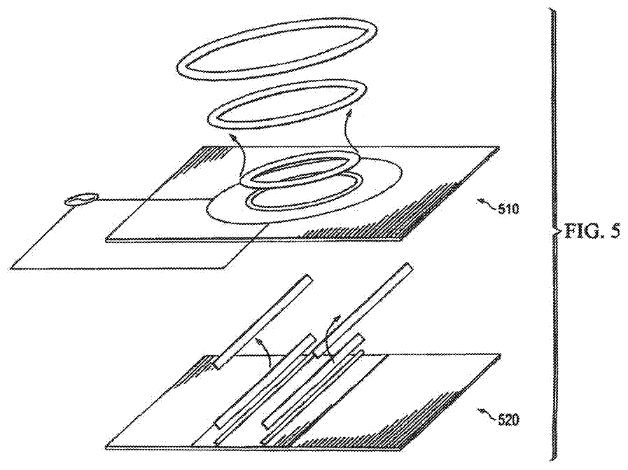

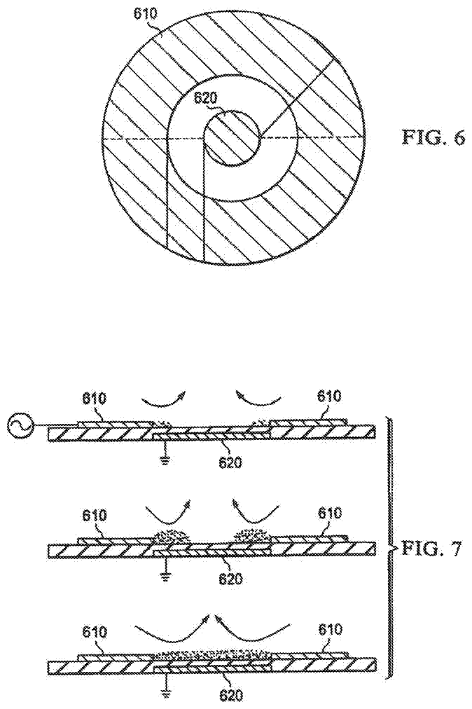

FIGS. 6 and 7 contain additional details of an annual embodiment. In the configuration of FIG. 6, note that the amount of plasma generated and the corresponding motive force can be varied by increasing the voltage differential that is supplied to the electrodes 610 and 620 as is illustrated generally in FIG. 7.

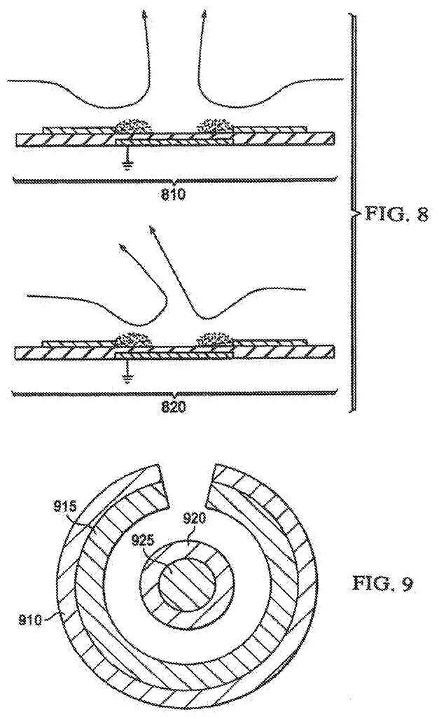

FIG. 8 is a schematic cross-sectional illustration of the embodiment of FIG. 7 that shows that, although the motive force is generally directed orthogonally away from (or toward) the dielectric material, in some configurations and at some points along the embodiment of FIG. 7, the force may take a path that is non-orthogonal to the dielectric material.

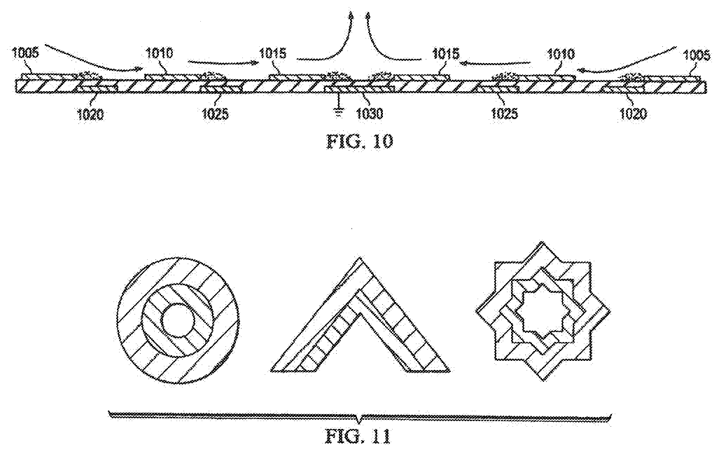

FIGS. 9 and 10 are schematic illustrations of still other arrangements that are generally annular. FIG. 9 contains an illustration of an annular embodiment that includes two upper electrodes 910 and 920 and two lower electrodes 915 and 925. Note that the electrodes 910 and 920 might be electrically isolated from each other or not. The same might also be said with respect to electrodes and 915 and 925.

FIG. 10 contains a cross-sectional view of still another annular embodiment, with upper electrodes 1005, 1010, and 1015, and lower electrodes 1020, 1025, and 1030. Note that in some embodiments (e.g., FIGS. 7, 8, and 10) one or more electrodes, e.g., the lower electrode in these figures, is embedded in the dielectric.

FIG. 11 contains some further embodiments, e.g., annular, chevron, and hybrid. Those of ordinary skill in the art will readily be able to devise other shapes and arrangements that generate plasma according to the instant disclosure.

Note that, although in some embodiments the dielectric is a generally rectangular single planar surface, in other embodiments it might be round, polygonal, etc. Additionally, in still other embodiments the dielectric might be separated into two or more pieces that are interconnected by conductive material. In such an instance, the electrodes of the instant disclosure might be placed on the same or different pieces of the dielectric. The dielectric and/or associated electrodes might also be non-planar depending on the requirements of a particular application. Thus, for purposes of the instant disclosure it should be understood that the term “dielectric” is applicable to materials that are any shape, that are planar or not, and that might be divided into multiple pieces that are joined by conductive materials.

Further note that for purposes of the instant disclosure, the term “length” should be broadly construed to be any linear dimension of an object. Thus, by way of example, circular dielectrics have an associated length (e.g., a diameter). The width of an object could correspond to a length, as could a diagonal or any other measurement of the dielectric. The shape of the instant electrodes and associated dielectric are arbitrary and might be any suitable shape.

Still further, note that the voltages applied to the top and bottom electrodes may be different. It is important that the voltage differential between the electrodes be sufficient for the generation of plasma, e.g., about 5 to 50 kV as was discussed previously. The positive electrode can either be on the top or the bottom of the dielectric and the orientation might be varied depending on the direction it is desired to have the plasma stream move.

Finally it should be noted that the term “offset” as used herein should be broadly construed to include cases where there is no overlap between the electrodes (e.g., configurations 425 and 430) as well as cases where there is substantial overlap (e.g., configuration 410). What is important is that the edges of the upper and lower electrodes not be completely coincident, e.g., one electrode or the other should have a free edge (or part of an edge) that does exactly overlay the corresponding electrode on the opposite surface.

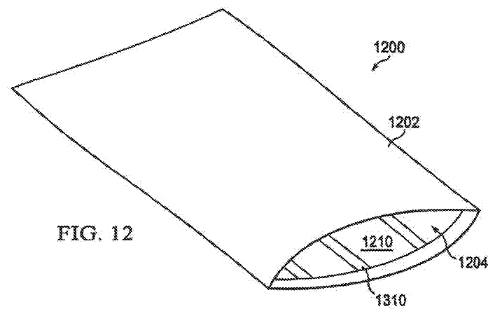

Referring now to FIG. 12 a perspective view of one embodiment of a plasma pouch decontamination device according to the present disclosure is shown. The pouch 1200 represents one application of the plasma generation devices disclosed herein. The pouch 1200 may be constructed in various sizes to allow sterilization of differently sized articles. For example, the pouch 1200 can have multiple compartments like a piano file, and/or it can be constructed to substantially conform to the geometric outline of the object device to be disinfected or sterilized. In other examples, the pouch 1200 can be produced as a mitten. A mitten or glove configuration may be constructed “inside out” such that plasma is generated on the exterior (e.g., for hand held decontamination of instruments). Some embodiments will provide a sheath-like sterilization pouch, which can be used to decontaminate the surfaces of long, serpentine bodies such as those of catheters and other devices.

The pouch 1200 may comprise a body portion 1202 that may be folded around on itself to create an interior 1210 of the pouch 1200. The body portion 1202 may be sealed at all but one edge that forms an opening 1204. The opening 1204 allows for insertion and removal of articles to be sterilized. Within the interior 1210 of the pouch 1200 a plurality of plasma generating electrodes 1310 can be seen. These electrodes 1310 may cover a portion, or substantially all, of the interior 1210 of the pouch 1200.

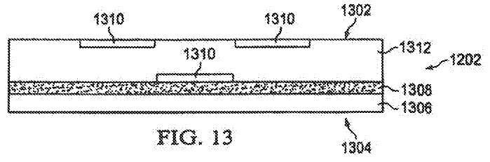

Referring now to FIG. 13, an end cutaway view of a portion of the plasma pouch 1200 is shown. The body portion 1202 can be seen to comprise an inner side 1302 corresponding to the interior 1210 of the pouch 1200, and an outer side 1304 corresponding to an exterior of the pouch 1200. The outer side 1304 may be covered by a flame and shock retardant material 1306 comprising an outer layer. This material 1306 may be similar to, or the same as, material utilized in fire resistant blankets. This may help to prevent any damage due to electricity or plasma to any objects or supporting surfaces outside the pouch 1200. The material 1306 may also protect against shorting or burnout of interior dielectric material.

A substrate 1308 may be provided under, or next to, the outer layer material 1306. The substrate 1308 may comprise materials such as Teflon® or polyethylene film. The substrate 1308 seals at least some of a plurality of electrodes 1310 against contact with air, and thus prevents generation of plasma on sealed surfaces. The pattern of the electrodes 1310 in the pouch can also implement various geometries (e.g., as discussed above). Thus, flow within the pouch 1200 can be controlled based on electrode geometry. In some embodiments, metallic tape or etched powdered electrodes may be used due to their flexibility.

The electrodes 1310 are restrained in a dielectric medium 1312. In some embodiments, the medium 1312 is a flexible film. This provides flexibility for the pouch 1200 and increases the number of geometries of electrodes that can be generated. The medium 1312 may range from less than 0.005 inches to about 0.010 inches in thickness. The thickness of the entire layer 1202 is only a few millimeters thick in some embodiments.

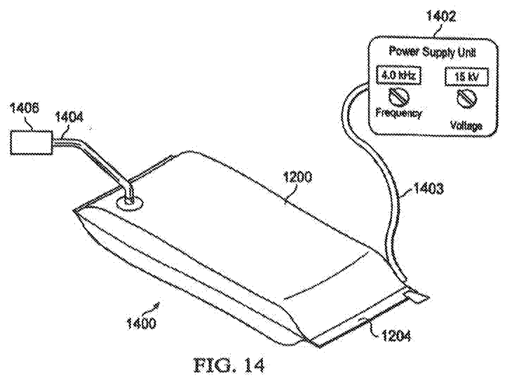

Referring now to FIG. 14, a perspective view of a system 1400 employing the plasma pouch 1200 of FIG. 12 for decontamination purposes is shown. The system 1400 employs a power supply 1402 that includes a transformer and a wall supply plugin. The power supply may provide a fixed voltage and frequency. In other embodiments, the power supply may have a variable voltage. In some cases the range will be from about 5 kV to 20 kV and may have a frequency between 600¬-5000 Hz. Switches and other controls may be provided for operation of the power supply 1402.

The power supply 1402 is electrically connected to the plasma pouch 1200 and to the internal electrodes (e.g., 1310 of FIG. 13). It is understood that a plurality of electrical leads may be combined into a single cord 1403 that enters the pouch 1200 (or pouch wall 1202) for connection to the electrodes 1310.

In operation, it may be useful to evacuate a certain amount of air from the pouch 1200 once the object to be decontaminated has been placed inside. This may result in a drop in the internal pressure of the pouch 1200 and/or a tendency for the pouch walls 1202 to adhere to the exterior of the contaminated object's surface. This helps reduce the distance between the plasma and the contaminated surface, allowing short lived species, such as Reactive Oxygen Species (ROS), to reach the surface of the object to be disinfected or sterilized.

The opening 1204 of the pouch 1200 may be sealable to prevent any gases and/or plasma generated species from escaping. This results in a complete inactivation mechanism. It also prevents a number of unwanted volatile gases and hazardous contaminants from escaping and potentially damaging nearby equipment or becoming a hazard to personnel.

Internally within the pouch 1200, vortices are generated due to the body forces in surface discharges. This results in complete mixing of all of the generated species to produce a very lethal “antimicrobial soup.” The byproducts generated in the process (e.g., ozone), may be ventilated out through a filter unit 1406 attached to outlet hose 1404. Activated carbon is one filter media that may be used. Other reducing agent embedded filters may also reduce byproducts such as ozone to a less harmful form. In a similar fashion, a number of other materials can be used to adsorb other byproducts such as NOx.

The pouch 1200 and/or the entire system 1400 may also be used for the purpose of cleaning surfaces through etching of both organic and inorganic molecules. Gaseous mixtures such as O₂ and CF₄ have a high etching ability when used as feed gas for plasma instead of air. In one embodiment, they are injected into the pouch 1200 via outlet hose 1404. Valving (not shown) may be utilized to allow the same hose 1404 to be used for evacuation of gases and byproduct and the introduction of gases into the pouch 1200.

The pouch 1200 may have a number of sensors and actuators to boost its performance. For example, the pouch 1200 may contain proximity sensors and/or electric relays to shut down the discharge if a short or burn-out is detected. Ozone and other particulate concentration sensors may be used to detect leaks in pouch 1200.

In some embodiments, the pouch 1200 may incorporate the use of dyes or other reactive chemical agents. For example, an azo dye can be used to determine whether a required sterility level has been achieved. Based on laboratory results, the timeframe utilized for sterilization may be adjusted.

It is understood that the pouch 1200 and/or the system 1300 can be replicated or expanded. For example, for large facilities, multiple pouch arrays can be established to run in tandem for a large number of articles to be sterilized. It is also understood that multiple pouches 1200 may be operated by a single power supply 1402.

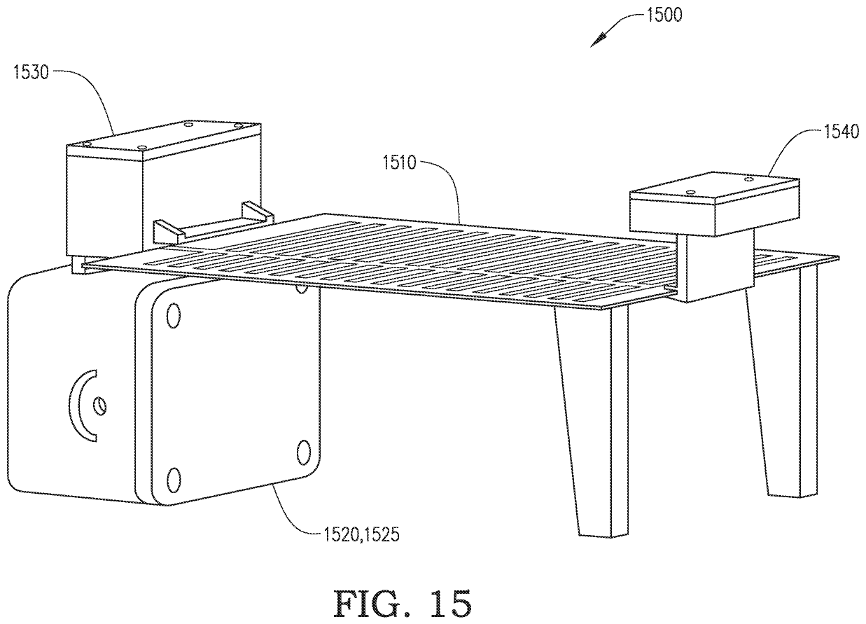

Referring now to FIGS. 15-17 a surface dielectric discharge (SDD) plasma generating apparatus is shown. Plasma generating apparatus or plasma generating device 1500 includes a plasma generating sheet 1510. Plasma generating apparatus 1500 may likewise include a power supply 1505, or voltage source of a type known in the art. The power supply may be a wall outlet or other known power source. A voltage transformer 1520 may be included, as may other components, such as for example signal generators for different frequencies and waveforms if necessary to create the necessary voltage differential for generation of plasma and plasma generated reactive species. Voltage transformer 1520 and power supply 1505 may be housed in a box 1525 that can also support and retain plasma generating sheet 1510. Other structural components 1530 and 1540 may house pneumatics, sensors, magnetic field monitors or other ancillary equipment.

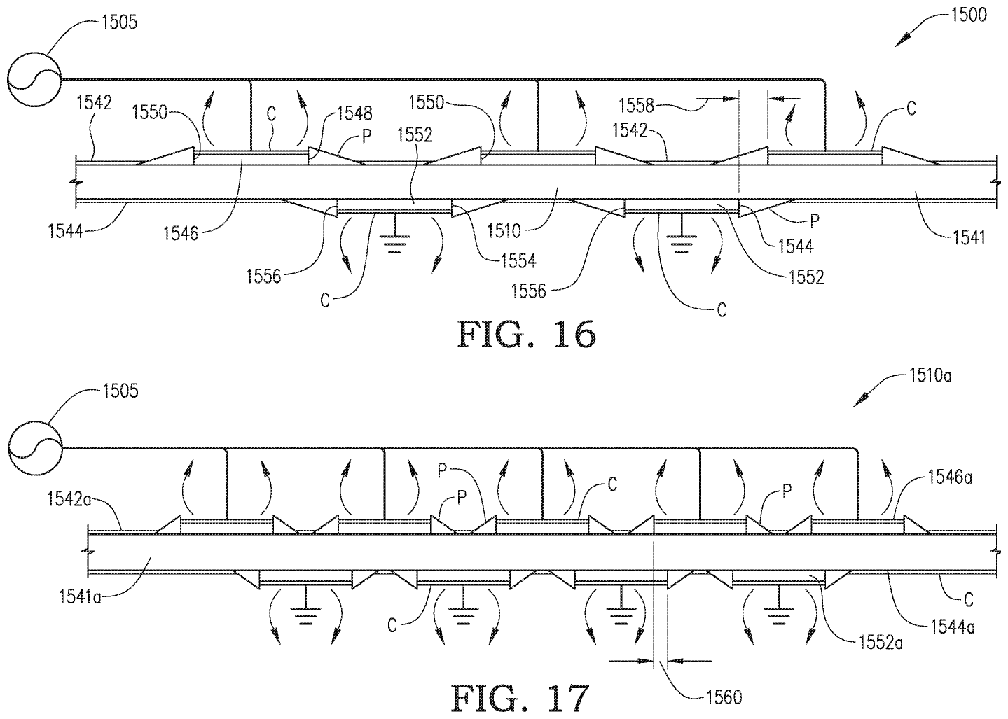

Plasma generating sheet 1510 comprises a dielectric barrier, or dielectric medium 1541 with first and second sides 1542 and 1544, respectively. A plurality of electrodes 1546, which may be referred to as first electrodes 1546, are positioned on first side 1542 of dielectric barrier 1541. Electrodes 1546 have a first edge 1548 and a second edge 1550. A plurality of electrodes 1552 are positioned on second side 1544 and may be referred to as second electrodes 1552. Second electrodes 1552 have a first edge 1554 and a second edge 1556. In an embodiment shown in FIG. 16 a gap, or space 1558 exists between first electrodes 1546 on first side 1542 and adjacent second electrodes 1552 on second side 1544.

In another embodiment shown in FIG. 17 an overlap 1560 exists between electrodes 1546a on first side 1542a of plasma generating sheet 1510a and adjacent second electrodes 1552a on second side 1544a. In the embodiment of FIG. 17 details are designated with the subscript “a” simply for identification purpose, and are identical to the corresponding features in the embodiment of FIG. 16. Discussions with respect to FIG. 16 apply equally to the embodiment of FIG. 17, other than the spatial relationship between the electrodes on the first and second sides of the dielectric medium. A non-plasma inhibiting coating covers at least a portion of electrodes 1546 and 1552, and in some embodiments all of electrodes 1546 and 1552 are covered by a non-plasma inhibiting coating. Plasma generating sheet 1510a is generally identical to plasma generating sheet 1510, except for the positioning of the electrodes on the first and second sides of the dielectric medium. The coating is such that it will not inhibit the generation of plasma and will extend the lifespan of plasma generating sheet 1510 and 1510a by protecting the electrodes from rapid corrosion which can occur as a result of highly oxidized plasma generated species. The coating is identified in the drawings with the letter C. The coating C may cover the exposed surfaces of the dielectric medium as well, and will provide the same protection to the plasma generating sheet and will protect the sheet from etching and/or corrosion. As an example, the coating may be a solder mask which can be more effective than metal coating. Other non-plasma inhibiting corrosion resistant coatings may be utilized and solder mask is mentioned here only as an example of an acceptable coating.

Power supply 1505 may be connected by leads to the first electrodes 1542 or to second electrodes 1552. In the embodiment shown power is supplied to first electrodes 1546 and second electrodes 1552 are connected to a ground. Power supply 1505 will likewise be connected to a ground. As a result, voltage applied to the first electrodes 1542 will create a voltage differential. By way of example only, these include voltages in the range of 5 to 50 kV at frequencies of 1,000 to 100,000 Hz at a 10% to 100% duty cycle at modulated frequencies of 1, 2, 5, 10, 100, 500 and 5000 Hz. It will be appreciated that various flow rates and associated decontamination characteristics can be generated by adjusting the duty cycle voltage and frequency of the applied voltage. In application, the limit is most likely to be due to the durability of the materials used to construct the device 100 and the available power supply. For example, if operating from commercial power, higher voltages may be available than if operating from battery power. Although in the embodiment shown leads are connected only to first electrodes 1546 on first side 1542 of dielectric barrier 1541 it is understood that leads may be connected to electrodes on both the first and second sides 1542 and 1544 to create the voltage differential. Transformers of a type known in the art, and generally referred to as step-up transformers may be utilized to step up the voltage to voltages necessary to generate a desired amount of plasma.

As depicted in FIGS. 16 and 17 the application of a differential voltage will generate plasma P at the first and second edges of both of first electrodes 1546 and second electrodes 1552. The coating C will not inhibit the creation of plasma. Plasma generated reactive species such as oxygen and nitrogen reactive species will be released from the plasma and will travel along the flow generated due to the electromagnetic field created by the coupling of motion between electrons and larger atoms and molecules. In the embodiment where a gap 1558 exists, the induced flow of plasma generated reactive species is greater than the embodiment in which an overlap 1560 exists. The power required to generate plasma and to induce flow of plasma generated reactive species in the embodiment where overlap 1560 exists is less than that required to induce flow of reactive species when a gap 1558 exists. While the configurations in FIGS. 16 and 17 depict generally parallel electrodes with a gap or overlap between electrodes on opposite sides of a dielectric barrier, it is understood that other configurations may be utilized to create a flow of reactive species. In an embodiment where gap 1558 exists between adjacent electrodes positioned on opposite sides of the dielectric barrier induced flow is increased over that where an overlap 1560 exists. In the configuration where an overlap 1560 exists, input requirements for power to generate plasma and induced flow of reactive species is less than that required where gap 1558 exists. In any case, plasma and reactive species may be generated simultaneously on both sides of dielectric barrier 1541, as there is no plasma inhibiting substrate to prevent the generation of plasma on either of sides 1542 and 1544.

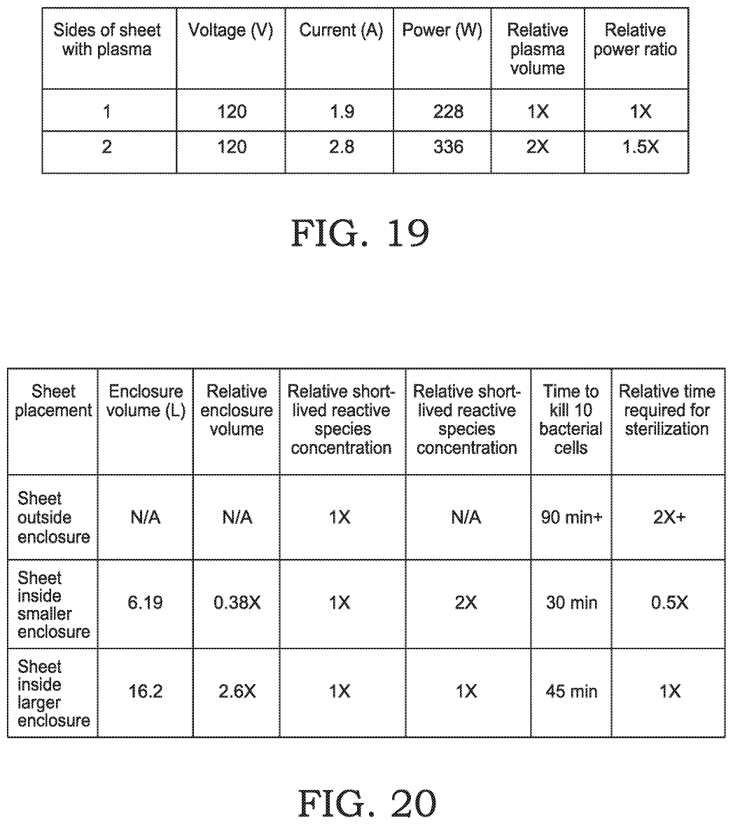

A plasma generating apparatus 1510 in which plasma is generated on both sides of the dielectric barrier will create more plasma and plasma generated reactive species than one which utilizes a sheet which generates plasma on only one side thereof. The table in FIG. 19 sets forth the results of a test that shows that with a power increase of approximately 50%, the plasma volume increased by 100%. Because plasma is created at greater speeds, decontamination of objects will occur more quickly with a sheet that generates plasma on both sides. The plasma sheets were Teflon® dielectric material, 1.6 mm thick and 7″ wide by 10″ long. The values were measured on the primary side of the transformer and are those drawn from the power outlet.

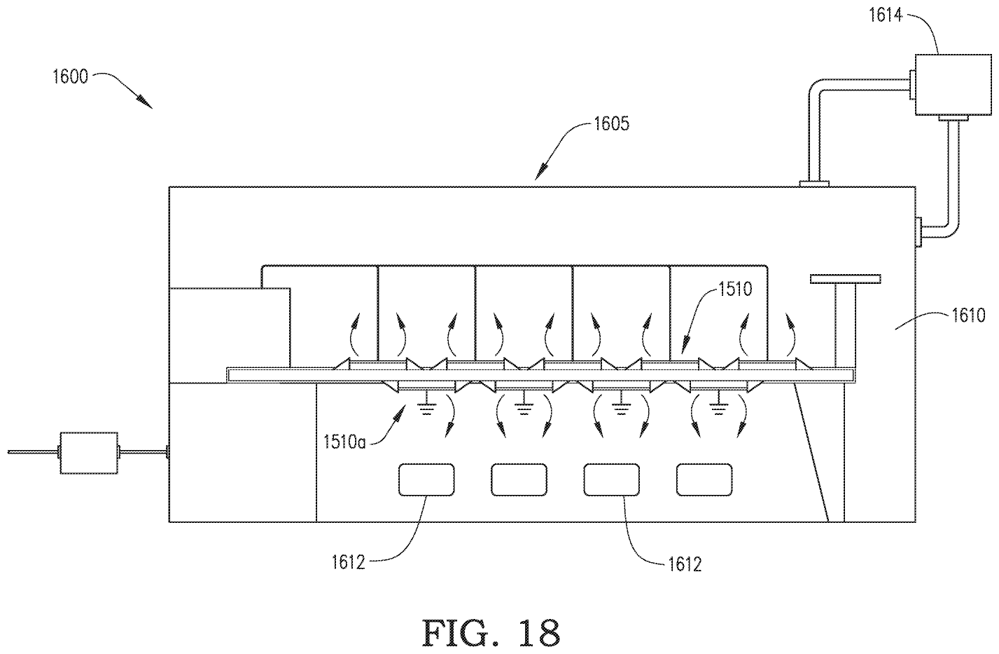

FIG. 18 shows decontamination chamber 1600 comprising plasma generating apparatus 1510 and a decontamination enclosure 1605 which is a sealed enclosure 1605. Enclosure 1605 has an interior 1610. A portion or all of plasma generating apparatus 1500 may be placed in the interior 1610. The decontamination chamber may be configured such that only the plasma generating sheet 1510 is placed in the interior 1610 and the power supply and other components are placed on the exterior thereof. Objects 1612 for decontamination or sterilization, which may be for example medical instruments, surgical instrument wraps, or other objects may be placed in the interior 1610 of the sealed enclosure 1605.

As described above power is applied to create a voltage differential between the first electrodes 1546 and second electrodes 1552. As a result, plasma P is created and plasma reactive species begin to flow as designated by the arrows in the enclosure 1600. Preferably, enclosure 1605 is filled with motive reactive species which will contact any object for decontamination. The decontamination chamber is designed for use at normal operating conditions, for example standard atmospheric pressure and room temperature. As a result the decontamination chamber 1600 is usable in virtually any environment.

The examples in the table in FIG. 20 show the effect of an enclosure volume on decontamination/sterilization efficiency. The tests used 10″×6″ plasma sheets with 1.6 mm thick Teflon® dielectric material at the same power input. Biological indicators (BIs) comprised of stainless steel discs inoculated with 10⁶ spores of Geobacillus sterothermophilus were used to evaluate sterilization efficiency. BIs were treated at a distance of five centimeters from the plasma sheet.

The examples in FIG. 20 used a plasma sheet 1510 for generating plasma on both sides of the sheet. Based on the examples, it can be seen that decontamination will occur much quicker when plasma sheets that are capable of generating plasma on both sides are used.

Plasma sheets generate high concentrations of reactive oxygen and nitrogen species when the plasma is ignited in air. Among the plasma species generated, ozone and nitrogen dioxide are among the most dominant and long-lived species, accumulating to high concentrations when plasma sheets are used inside an airtight enclosure. Ozone and nitrogen dioxide are both approved by the FDA for sterilization of medical instruments. Airtight enclosure 1605 inside which a plasma sheet 1510 is used to generate plasma and reactive species from air allows containment of plasma generated reactive species, increased concentrations of plasma generated reactive species, and increased relative pressure as a result of increased heat. These features provide increased decontamination or sterilization efficiency and increased user safety.

Since ozone, nitrogen dioxide, and other reactive oxygen and nitrogen species are highly corrosive of metals and degrade other materials by oxidation, all components and materials used within close proximity to plasma sheets need to be resistant to oxidation. Common materials that need to be avoided are nylon or polyamide plastics, acetal, rubber, nitrile, neoprene, uncoated ferrous metals (excluding stainless steel), and most uncoated nonferrous metals.

A pump 1614 may be utilized to pump plasma generated reactive species into and out of enclosure 1605. Different pulsing and pumping regimes may be utilized to control the generation of heat in the enclosure 1605, which will increase the life of the sheet 1510. Pump 1614 can be used to pump plasma generated reactive species out of the enclosure 1605 through a filter that converts the reactive species back to oxygen and nitrogen and back into enclosure 1600. This recirculation of the gaseous contents of enclosure 1605 allows replenishing of the short lived plasma species, relieves accumulated heat and pressure within the enclosure, and removes potentially harmful reactive species before opening the enclosure after a sterilization cycle is complete. It is understood that air, or other gaseous mixtures known in the art may be used as a feed gas for plasma generation.

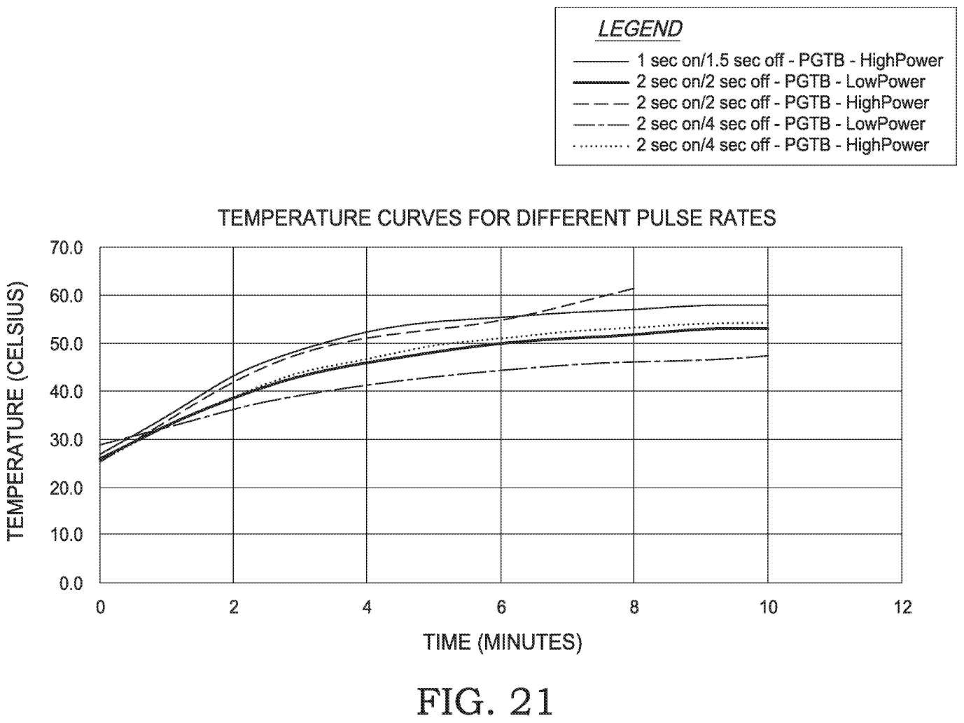

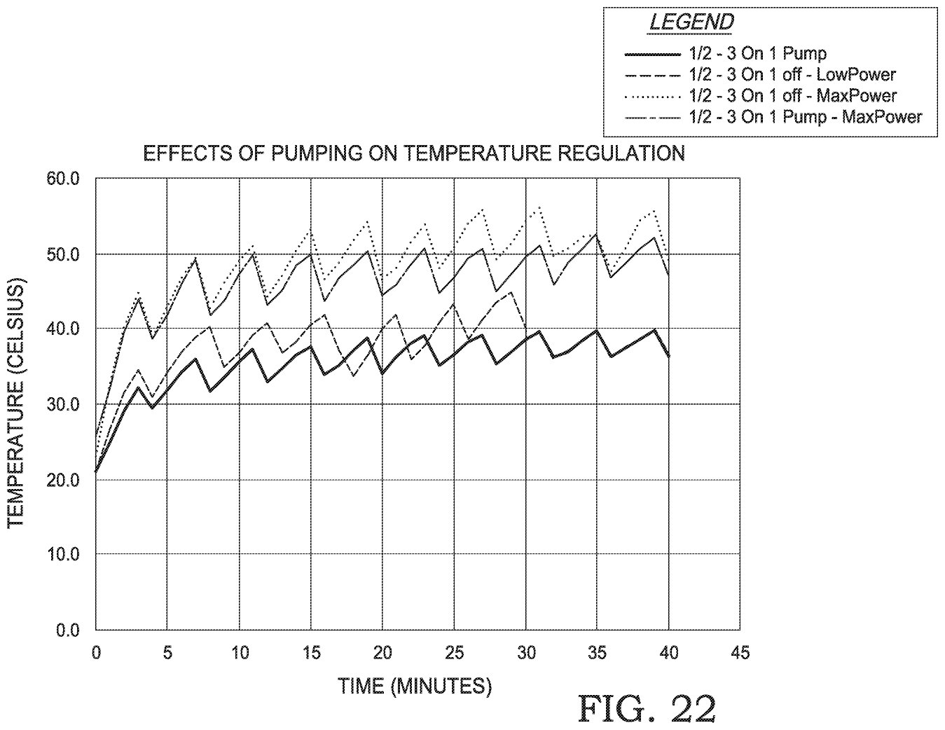

The graphs in FIGS. 21 and 22 reflect the impact of different power pulse and pump pulse regimes on temperature inside an enclosure. The first graph reflects temperature using different power pulse, or plasma generation pulse rates. For example 1 sec on/1.5 sec off reflects power on and off and therefore plasma generation active for 1 second and inactive for 1.5 seconds. The graph in FIG. 22 shows temperature at different power pulse and pump pulse rates. For example ½ 3 on 1 pump reflects a pattern of running the ½ power pulse rate as described earlier (power on for one second and off for two seconds for 3 minutes, and then running a circulating air pump for one minute in which no plasma is generated. Where the term off as opposed to pump is used, the system rests, so that no plasma is generated, and no pumping occurs.

The top line of the graph in FIG. 22 relates to 3 on 1 off Max Power and the line immediately below relates to 3 on 1 pump Max Power. The bottom line reflects plasma generation at Low Power, and relates to 3 on 1 pump at low power, and the line immediately above the bottom line corresponds to 3 on 1 off at low power. The goal of evaluating the effects of heating with different pulsing regimes was not to gain any benefit for plasma generation or decontamination efficiency; rather, the goal was to extend the usable lifespan of the plasma sheets. Plasma generating sheets are destroyed via more rapid etching through the dielectric material if they heat up too highly or too quickly. The various pulsing regimes were done to reduce heating while still having the longest possible amount of plasma “on” time. When plasma sheets are exposed to higher temps the life expectancy can be as short as one hour when run continuously. By using pulsing of power and or pump rates, the life of the plasma sheets can be extended significantly, for example for as long as eleven hours when using a Teflon® material.

Differing plasma pulse rates (e.g., 7 sec on, 13 sec off; 4 sec on, 7 sec off, etc.), can be used and the purpose is to increase the distance of reactive species propulsion by the induced airflow while also balancing plasma sheet heating. A longer “on” or plasma generation time results in increased airflow and stronger “pushing” of the short-lived (and long-lived) reactive species to distant surfaces; however, a longer “on” time also results in increased heating. In any event the application of power pulsing, and/or pump pulsing can effectively extend the life of the plasma sheets used in an enclosure for the decontamination/sterilization of contaminated objects.

The enclosure may be permanently fixed to the voltage transformer and user controls that provide power to the plasma sheet or may be detachable through the use of a suitable docking mechanism for the electronic and pneumatic (gas removal/recirculation) contacts. A safety interlock such as a magnetic locking mechanism may be incorporated to keep the user from accidentally opening the enclosure while the device is running. An ozone sensor is used to detect any leaks and gives an alarm when a leak is detected. Temperature, pressure, and humidity sensors can be used to ensure correct operating conditions within appropriate ranges at various altitudes, locations, and atmospheric conditions. Silica gel may be placed inside the enclosure to absorb or emit moisture as needed within the enclosure. Air may also be passed through a desiccant filter via a pump and reinserted into the enclosure. A fan may be mounted strategically inside the enclosure for circulation and distribution of heat and plasma generated species. Phase change materials, heat tubes, and/or heat sinks may be used to reduce the heat generated by the plasma sheet by mounting or arranging the same in close proximity or in direct contact with the plasma sheet.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A plasma generating apparatus comprising:
a dielectric medium;
a plurality of first electrodes positioned on a first side of the dielectric medium;
a plurality of second electrodes positioned on a second side of the dielectric medium; and
a power supply connected to the electrodes on one of the first or second sides and configured to create a voltage differential between first electrodes and second electrodes, wherein plasma is generated on both of the first and second sides of the dielectric medium in response to the applied voltage differential.

2. The plasma generating apparatus of claim 1 wherein at least a portion of a plurality of the first and second electrodes are coated with a non-plasma inhibiting corrosion resistant material.

3. The plasma generating apparatus of claim 1, wherein side edges of the plurality of first electrodes are spaced apart from side edges of adjacent second electrodes to define a lateral gap therebetween.

4. The plasma generating apparatus of claim 1, wherein the power supply is configured to provide power pulses of a designated length of time.

5. A decontamination chamber comprising a sealed enclosure, the dielectric medium and first and second electrodes of claim 1 being positioned in an interior of the sealed enclosure.

6. The decontamination chamber of claim 5, further comprising a pump configured to pulse between on and off positions, wherein in the on position the pump removes plasma generated reactive species from the sealed enclosure and pumps air into the sealed enclosure.

7. A method of forming plasma comprising:
positioning electrodes on both of first and second sides of a dielectric medium; and
simultaneously creating plasma on both of the first and second sides of the dielectric medium.

8. The method of claim 7, wherein the simultaneously creating step comprises applying a voltage to the electrodes on at least one of the first and second sides of the dielectric medium to create a voltage differential.

9. The method of claim 8, further comprising coating at least a portion of the electrodes with a non-plasma inhibiting corrosion resistant material.

10. The method of claim 8, further comprising:
enclosing the dielectric medium in an enclosure; and
generating reactive species in the enclosure.

11. The method of claim 10 further comprising:
pumping the generated reactive species from the enclosure; and
pumping air into the enclosure.

12. The method of claim 10 further comprising:
placing an object to be decontaminated in the enclosure; and
exposing the object to the reactive species in the enclosure for a predetermined length of time to decontaminate the object.

13. The method of claim 8 wherein the applying step comprises providing power pulses of designated lengths of time with power lapses therebetween.

14. A decontamination chamber comprising;
a sealed enclosure:
a dielectric medium positioned in the enclosure;
a plurality of electrodes on both of first and second sides of the dielectric medium; and
a power source configured to generate a voltage differential between electrodes on the first side of the dielectric medium and the electrodes on the second side of the dielectric medium, the voltage differential creating plasma adjacent the electrodes on both sides of the dielectric medium.

15. The decontamination chamber of claim 14, further comprising a pump configured to pump plasma generated reactive species out of the enclosure and to pump air into the enclosure at preselected intervals.

16. The decontamination chamber of claim 14, further comprising a non-plasma inhibiting corrosion resistant coating covering at least a portion of the electrodes.

17. The decontamination chamber of claim 14 wherein the power source provides power pulses of predetermined length.

18. The decontamination chamber of claim 14, wherein plasma generated reactive species are released from the plasma in the enclosure in sufficient quantity to decontaminate an object placed in the enclosure.

19. The decontamination chamber of claim 14, the electrodes on the first side having first and second edges and the electrodes on the second side having first and second edges, wherein the edges of the electrodes on the first side are spaced apart from the edges of adjacent electrodes on the second side.

20. The decontamination chamber of claim 14, wherein the electrodes on the first side overlap adjacent electrodes on the second side.
